(19) United States
(12) Patent Application Publication
(10) Pub. No.: US 2005/0128967 A1
(43) Pub. Date: Jun. 16, 2005

(54) Identifying services provided via IP and similar packet networks, and service usage records for such services

(76) Inventor: Donald MacGregor Scobbie, Edinburgh (GB)

Correspondence Address: Paul D. Greeley, Esq.;Ohlandt, Greeley, Ruggiero & Perle, L.L.P., 10th Floor, One Landmark Square, Stamford, CT, 06901-2682, US

(21) Appl. No.: 11/014,047

(22) Filed: Dec. 16, 2004

(30) Foreign Application Priority Data
Dec. 16, 2003 (GB) 03 29 070.7

(51) Int. Cl. H04B 7/00

(52) U.S. Cl. 370/310

(57) ABSTRACT

A service key is assembled from information in data packets traversing a communications link, to enable identification of services implemented via the data packets.

This invention relates to methods and apparatus for identifying services provided via Internet Protocol (IP) and similar packet networks, and for creating service usage records summarising usage of such services, for example via the General Packet Radio Service (GPRS) that can be provided in GSM mobile phone networks.

### BACKGROUND ART

GSM mobile phone networks use a signalling system to coordinate their operation. This signalling system is typically operated in accordance with the ITU Signalling System No. 7 (SS7) suite of protocols. It is known to monitor SS7 signalling messages traversing the signalling system in order to observe the operation of the network, and to obtain information about usage of the network's facilities. Such information is often collected in Call Detail Records (CDRs) (e.g. for voice calls) and Transaction Detail Records (TDRs) (e.g. for the use of other GSM services). For example SS7 ISDN User Part (ISUP) protocol messages are used to build CDRs to summarise voice service use, and SS7 Mobile Application Part (MAP) protocol messages, supported by the Transaction Capabilities Application Part (TCAP) protocol, are used to assemble summaries of messaging, mobility and access management activity.

To provide analogous functionality in GPRS networks, an additional transaction builder is required to summarise IP service usage, for example of web browsing and e-mail services. The resulting transaction summaries are usually referred to as IP Data Records (IPDRs) or Service Usage Records (SURs). An example of a system for building such SURs is described in UK patent application no. 03 13 812.0 and corresponding U.S. patent application Ser. No. 10/865,573.

When data service usage records are built, it is desirable to be able to identify the actual data service being used. Wireless applications currently being introduced in GPRS networks have used the GPRS Access Point Name (APN) and application protocol to discriminate between services. For example, a single APN may be used to host Wireless Application Protocol (WAP) services, and all WAP traffic in the GPRS core network is routed through this APN. Consequently identification of the relevant APN alone is sufficient to be able to identify WAP traffic flows in the network. All service usage records created in respect of this APN can be tagged as ‘WAP Service’, and management and reporting applications can use this tag to model and report WAP activity in the network.

However, many services may be multiplexed over a single APN. For example, a system may use a single APN to support a facility in which ring-tone downloads, Multimedia Messaging Service (MMS) messages, audio clips and road traffic services are all available. In order to differentiate between these services, APN and application protocol might in principle be considered for use in combination. However clients on this system use WAP as the application protocol for services in the APN, and most GPRS devices use WAP exclusively for service access. Hence, ring-tone downloads and road traffic services that are provided by different third party suppliers cannot be distinguished from one another. A further shortcoming in using APN is that it is solely a GPRS and Universal Mobile Telecommunications System (UMTS) concept, with no equivalent in wireline or CDMA2000 networks.

The requirements for effective identification of services provided over IP and similar networks are:
1. The method should be applicable to both wireless (GPRS, UMTS and CDMA2000) and wireline data networks.
2. It should work for networks using either the IPv4 or IPv6 protocols.
3. Service discrimination based on content is highly desirable. In practice, data service modelling and management are more closely related to content type rather than application protocol or transport protocol used to deliver the data.

The most frequently encountered service identification mechanism currently used in IP networks is simple port mapping, accomplished using the standard/etc/services file provided in Unix® operating systems. For example, e-mail services are provided by the Simple Mail Transfer Protocol (SMTP), Post Office Protocol (POP) and Internet Message Access Protocol (IMAP) and can be reported as such if port numbers 25 (SMTP), 109 (POPv2), 110 (POPv3) or 143 (IMAP) are observed in a protocol message related to a service being provided over IP. However, e-mail protocols can be used to deliver many different kinds of content (text, HTML, audio and video) and content type cannot be identified using port number alone. More complex and expensive content analysis must be done to determine the content type. Thus relying on port number or application protocol to determine content type is as unsatisfactory as use of APN.

### DISCLOSURE OF INVENTION

According to one aspect of this invention there is provided a method of identifying a service provided via a packet data system, comprising the steps of:
monitoring data packets traversing a communications link to support a data transport service in a communications network;
deriving in accordance with content of said data packets first information for identifying any access point involved in the data transport service;
deriving in accordance with content of said data packets second information identifying network address and port number associated with an application service provided involved in the data transport service;
deriving in accordance with content of said data packets third information comprising a uniform resource identifier associated with the data transport service; and
concatenating the first, second and third information to provide an identification of the data transport service.

Thus, for example, content can be represented by use of four variables observed from data packets (signalling and data). Service usage can then be modelled without the need to do any actual examination of the content passed between the server and the client or of the reason for the data transfer.

According to another aspect of this invention there is provided apparatus for identifying a service provided via a packet data system, comprising:
a monitor for monitoring data packets traversing a communications link to support a data transport service in a communications network;
a first deriver for deriving in accordance with content of said data packets first information for identifying any access point involved in the data transport service;
a second deriver for deriving in accordance with content of said data packets second information identifying network address and port number associated with an application service provided involved in the data transport service;
a third deriver for deriving in accordance with content of said data packets third information comprising a uniform resource identifier associated with the data transport service; and
a concatenator for concatenating the first, second and third information to provide an identification of the data transport service.

### BRIEF DESCRIPTION OF DRAWINGS

A method and apparatus in accordance with this invention, for creating SURs summarising use of a GPRS system and including identification of services provided via the system, will now be described, by way of example, with reference to the accompanying drawings, in which:

FIG. 1 is a block schematic diagram of a GSM mobile communications network incorporating equipment for providing GPRS service;

FIG. 2 shows a protocol stack used on a GPRS Gn interface connecting an SGSN to a GGSN; and

FIG. 3 is a schematic diagram of major functional blocks in a system for creating SURs including identification of data services being provided.

### DETAILED DESCRIPTION

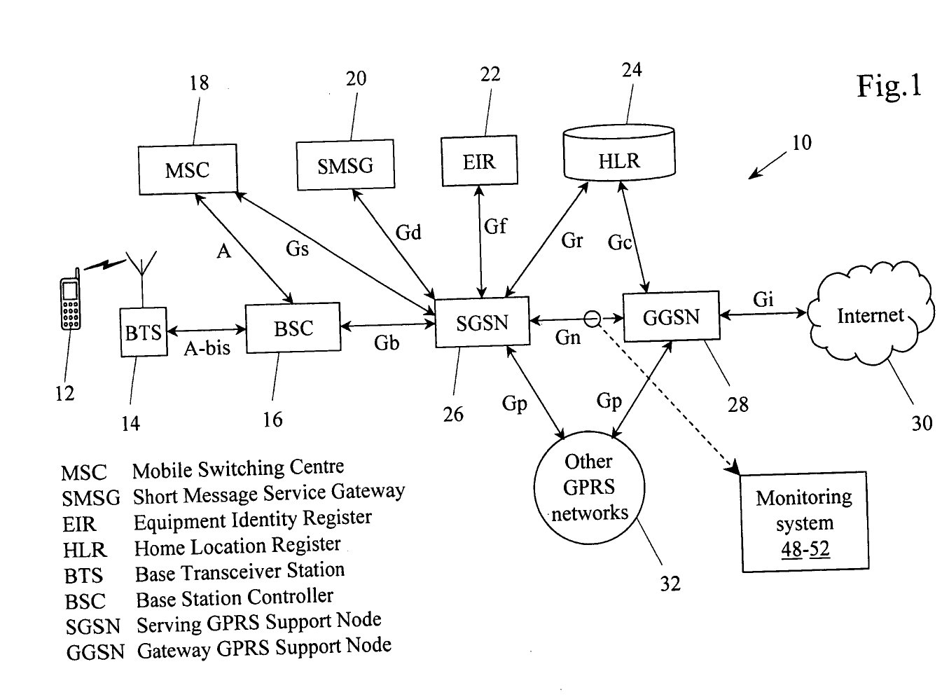

FIG. 1 shows the major functional components of a GSM network 10 configured to provide GRPS service. Referring to FIG. 1, a mobile station (MS) 12 communicates over an air (RF) interface with a base transceiver station (BTS) 14 under the control of a base station controller (BSC) 16. The connection of voice calls to the MS 12 is coordinated by a mobile switching centre (MSC) 18, and short message service (SMS) functionality is provided by an SMS Gateway (SMSG) 20. Administrative information about the MS 12 and the subscriber are held in databases comprising an equipment identity register (EIR) 22 and a home location register (HLR) 24. Those skilled in the art will recognise that a complete GSM system typically incorporates additional equipment not shown in FIG. 1, such as a visitor location register (VLR). However, such equipment that is not directly relevant to implementation of the present invention has been omitted from the figure for the sake of clarity.

In order to provide GPRS service, the system also incorporates a Serving GPRS Support Node (SGSN) 26 and a Gateway GPRS Support Node (SGSN) 28. The SGSN 26 routes packet-switched data to and from the MSs within the area it serves. Its principal functions are packet routing, mobile attach and detach procedures, location management, assigning channels and time slots, authentication and charging for calls. The GGSN 28 acts as an interface between the GPRS system and the external packet data network, i.e. the internet 30 shown in FIG. 1. It converts GPRS packets received via the SGSN 26 into the appropriate Packet Data Protocol format (e.g. Internet Protocol) and forwards them into the external internet 30. Likewise it converts IP addresses in received packets into GSM addresses of destination MSs, and routes the converted packets to the appropriate SGSN 26.

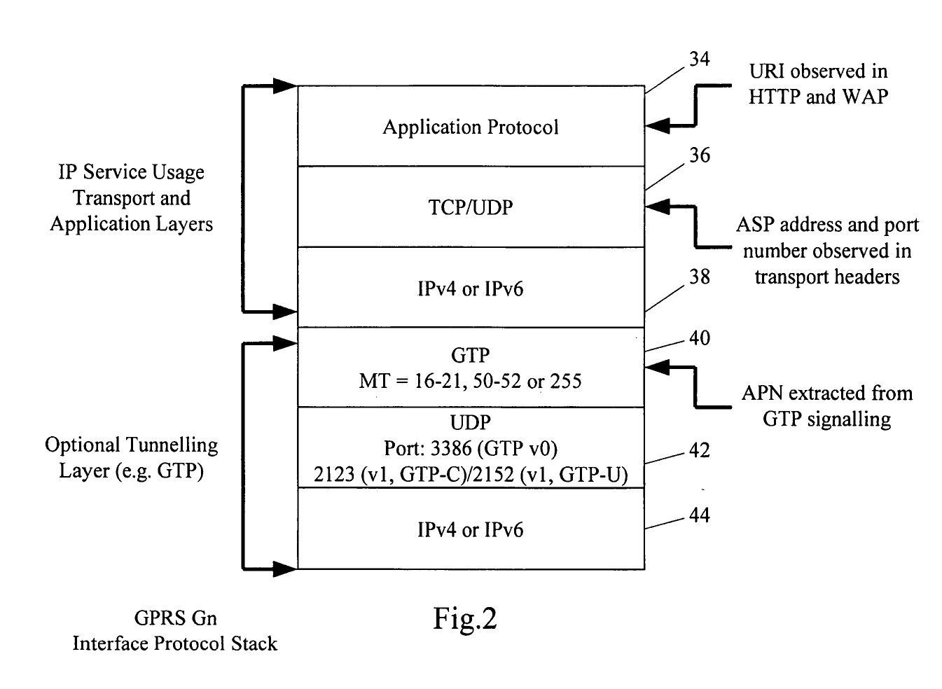

The GPRS specifications define various interfaces for connecting the SGSN 26 and GGSN 28 to the other components of the GPRS system, as follows:
Gi, for communications between the GGSN 28 and the external internet 30;
Gc, for communications between the GGSN 28 and the HLR 24;
Gn, for communications between the GGSN 28 and the SGSN 26;
Gr, for communications between the SGSN 26 and the HLR 24;
Gf, for communications between the SGSN 26 and the EIR 22;
Gd, for communications between the SGSN 26 and the SMSG 20
Gs, for communications between the SGSN 26 and the MSC 18;
Gb, for communications between the SGSN 26 and the BSC 16; and
Gp, for communications between from SGSN 26 and the GGSN 28 to GSNs in other GPRS networks 32.
   The signalling links over which these interfaces are implemented carry signalling packets containing signalling information for creating, updating and deleting GPRS connections, and other information required in support of these functions, such as for authentication, MS location and mobility support. In addition, some of the links, such as those for the Gi, Gn and Gb interfaces, carry data payload packets (i.e. packets containing data being exchanged between the MS 12 and the external internet 30). [00151 Each interface is implemented by means of a protocol stack, enabling the required functionality to be defined by reference to various widely-used communications protocols, such as the Transmission Control Protocol (TCP), User Datagram Protocol (UDP), GTP and IP. FIG. 2 shows the protocol stack for the Gn interface between the SGSN 26 and the GGSN 28. Referring to FIG. 2, user application protocol data at layer 34 are encapsulated in TCP or UDP packets comprising the next layer 36, and these are in turn are carried over IP (layer 38—as shown, either IPv4 or IPv6 can be used). The layers 34 to 38 comprise the transport and application layers for use by a subscriber of the IP service provided by GPRS.

In the case of GPRS, the IP packets in the layer 38 are “tunnelled” over the IP links to the GPRS network elements (particularly the SGSN 26 and the GGSN 28), that is each packet is encapsulated inside another IP packet and carried to the destination without altering the content of the encapsulated packet. This approach is adopted in order to prevent the network elements from being addressed directly from outside the network, thereby increasing security. This encapsulating packet is formatted as specified in GTP, as shown at 40, with a Message Type (MT) value in the packet header of 255, indicating that the packet contains user data. GTP messages are transferred using the UDP path protocol (layer 42), over IPv4 or IPv6 (layer 44). The layers 40 to 44 comprise the telecoms tunnel signalling layers.

As described in the afore-mentioned UK patent application no. 03 13 812.0 and U.S. patent application Ser. No. 10/865,573, by monitoring packets traversing the On interface links. (as described below) it is possible to perform both telecoms signalling analysis and service usage analysis at the same time, because the Gn protocol stack contains sufficient information for this purpose. Signalling transactions that maintain the GPRS network tunnel can be monitored by a state machine within the monitoring system that refers only to the lowermost three layers (40 to 42) of the stack. Service usage by subscribers can be monitored using only the upper three layers (34 to 38) of the stack, but a state machine for doing this has instant access to the signalling information available from the signalling analysis state machine.

In practice an SUR generator may be implemented, for example, by combining three complementary state machines:
a GTP Follower state machine that runs at the telecoms tunnel layer (40 to 44);
a Call Record Generator (CRG) for the service transport layer (36 and 38);
and one or more Content Analysis (CA) state machines for the service application layer (34).

The GTP Follower state machine processes every message monitored on the Gn interface links. If a message is a GTP signalling message it is processed as follows:
Create PDP Context Request messages and Create PDP Context Response messages are used to construct a CREATE transaction for the tunnel record, and to create internal accounting and control structures for tracking use of the tunnel associated with the requested context. Subscriber IMSI and network APN fields are stored at this point for the tunnel lifetime. The network QoS value is also set at this point, but it may be modified subsequently.
Update PDP Context Request and Update PDP Context Response messages are used to construct an UPDATE transaction. This is used principally to maintain the network QoS values for the tunnel.
Delete PDP Context Request and Delete PDP Context Response messages are used to construct a DELETE transaction, which is used to finalise any service usage analysis activities and to destroy the accounting and control structures for the tunnel.

All GTP messages with an MT value of 255 are validated against the existing control structures in the monitoring system, and then passed to the CRG and CA state machines for further analysis. When an SUR is ready to be released by these state machines, the telecoms context information from the signalling analysis performed by the GTP Follower is immediately available to be combined with that SUR.

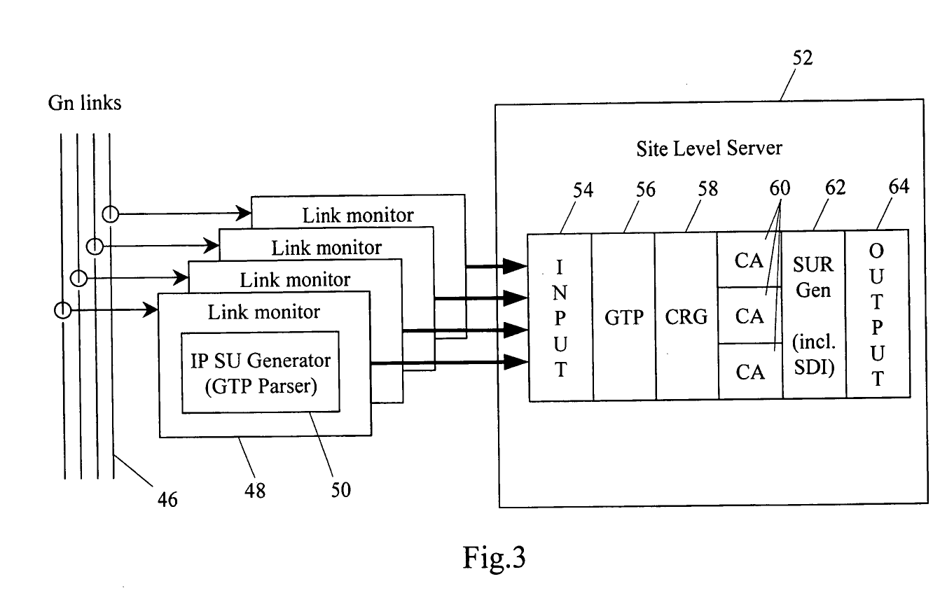

The processes outlined above will now be described in greater detail with reference to FIG. 3, which shows the major functional blocks in apparatus for implementing these processes. Referring to FIG. 3, Gn links 46 are connected to link monitoring cards 48 to enable the packets traversing these links to be passively monitored. The monitoring is passive in the sense that the operation of the links 46 is undisturbed by the presence of the connection to the cards 48. Each card 48 comprises an interface and a processor operating under the control of software program instructions in a memory (which is also used for data storage). The interface couples the respective card 48 to a link 46 in such a way that the operating characteristics of the link are not altered. In the case of optical links 46, for example, the connection may comprise an optical power splitter; for electrical links the connection may be a bridging isolator, or in the case of an Ethernet network LAN taps may be used.

The program instructions for the processor in each monitoring card 48 include code implementing a GTP parser 50, for generating records of the content of IP signalling units. The GTP parser 50 selects GTP signalling and protocol messages from the network. It does this by monitoring IP traffic on the Gn interface links and selecting UDP traffic with a source or destination port number of 3386 (GTP v0), 2123 (GTP v1, GTP-C control plane messages) or 2152 (GTP v1, GTP-U user plane messages).

A further optional stage to the selection of traffic from the network can be applied by filtering on the destination IP address in the outer layer of IPv4/IPv6. This enables traffic destined for the interfaces of one particular network element (GGSN or SGSN) to be selected. It also facilitates the partitioning of IP traffic by address space so that processing capacity can be managed at the level of the monitoring cards 48.

The GTP header in each selected packet is parsed to extract the MT field value and packets with the following types are selected and time stamped for further processing:
Create PDP Context Request (MT=16)
Create PDP Context Response (MT=17)
Update PDP Context Request (MT=18)
Update PDP Context Response (MT=19)
Delete PDP Context Request (MT=20)
Delete PDP Context Response (MT=21)
SGSN Context Request (MT=50)
SGSN Context Response (MT=51)
SGSN Context Acknowledge (MT=52)
T-PDU (GTP v0), G-PDU (GTP v1) (MT=255)
   All other GTP message types are discarded.

The selected GTP messages are then forwarded by the link monitoring cards 48 to a central (e.g. site level) server 52 for further processing, where they are received by an Input Manager module 54. This module collates and time-orders the GTP messages from the GTP parsers in the monitoring cards. The time ordering is based on a sliding window of the time stamps applied by the GTP parsers, the size of the sliding window being adapted to the volume and throughput of traffic from the input sources. The Input Manager modules then passes the time-ordered messages to a GTP module 56 that implements the GTP Follower state machine.

The GTP module 56 provides two functions. Firstly, it processes GTP signalling messages to maintain its tracking of tunnel state information, and secondly, it forwards all protocol messages that contain a payload length value greater than zero in the GTP header.

The information provided for each tunnel is:
IMSI and NSAPI (Network Service Access Point Identifier);
APN;
QoS Profile;
Tunnel start address (SGSN);
Tunnel end address (GGSN).

Each message processed by the GTP module 56 is examined to see if it is a T-PDU/G-PDU or one of the signalling messages selected by a GTP parser 50. Signalling messages are used by the GTP module 56 to maintain tunnel state information and are not passed on to the other components.

The T-PDU/G-PDU messages are associated with the tunnel context in which they are being carried and are passed on to the CRG module for further processing.

The GTP module 56 provides a service interface that the other system components use to obtain access to a per-tunnel data area in which private state information may be kept by each component, and in which the SUR is assembled for output.

Another service provided by the GTP module 56 is the identification of ‘traffic flow direction’, information that is made available to the other system modules. The packet direction determination method used by the GTP module 56 is simple, efficient and dynamic. Processing of the GTP signalling information allows the GTP module 56 to identify and maintain a cache of the relatively small number of GGSN addresses in the network. As all tunnel activity must originate or terminate at a GGSN, each monitored message can be tagged as Mobile Originated or Mobile Terminated by this module. As can be seen in FIG. 2, the bottom layer 44 in the protocol stack is the tunnel IP layer and the addresses are always those of SGSNs 26 and GGSNs 28. Analysis of the Create PDP Context messages (MT=16) allows a set of GGSN addresses to be created dynamically.

For example, both GTPv0 and GTPv1 Create messages always have a source address that is an SGSN interface and a destination address that is a GGSN interface. As signalling messages are processed (and as new GGSNs are added to the network), monitoring of these signalling messages reveals the new interface addresses. As soon as a GGSN address is placed in the cache, the direction of the tunnelled data, which starts at the upper IP layer in FIG. 2, can be determined from the rule: if the tunnel destination address is a GGSN, the tunnelled data is Mobile Originated, else the tunnelled data is Mobile Terminated.

Thus hundreds of thousands of wireless device addresses and tens-of thousands of core network addresses may be ignored. Knowledge of just tens of tunnel endpoint addresses allows the system to determine, with absolute accuracy, whether a packet is Mobile. Originated or Mobile Terminated. Further this method uses tunnel signalling messages to determine dynamically the IP addresses of the tunnel endpoints. Data tunnel Create, Update and Delete signalling messages are used to cache the IP addresses of the servers that provide the network tunnels. In any GPRS or UMTS network there are relatively few tunnel servers, and tunnels originate at an SGSN and terminate at a GGSN. There are always fewer GGSNs in a network, so the address set for them is smaller than for SGSNs. A large network may have, for example, six SGSNs and four GGSNs; each GGSN has two IP network interfaces. Thus an IP address set of eight elements would be sufficient to determine the transmission direction of all wireless data traffic in the network.

For the purposes of identifying data services being carried by the IP packets, the GTP module 56 also stores GPRS or UMTS Access Point Names that it derives by inspection of the contents of the GTP signalling packets. These APNs are made available to a service discovery interface (SDI) module that forms part of an SUR formatter 62 described below.

A CRG module 58 builds records of TCP and UDP transactions, or ‘flow summaries’, from the forwarded T-PDU/G-PDU protocol messages, using only the inner or tunnelled IP and TCP/UDP headers (layers 36 and 38 in FIG. 2).

One function of the CRG module is to aggregate individual measurements into a single summary record. Measurements created by this module may include packet and octet counts attributed to each service activation and the identification of anomalous packet and octet sequences that adversely affect network performance. This count information is conveniently split between upstream (Mobile Originated) and downstream (Mobile Terminated) counts.

The CRG module 58 processes all the T-PDU/G-PDU messages forwarded by the GTP module 56. However, it will only pass on those actually containing application layer content; those containing only transport signalling are filtered out of the processing stream by this module.

In the example depicted in FIG. 3 single CRG module 58 builds summary records for the service activation TCP and UDP transport layers. If it is desired to extend the system's capability to other transports such as Wireless Session Protocol (WSP) and Wireless Datagram Protocol (WDP), which are used to deliver Wireless Application Protocol (WAP) services, a separate Wireless CRG (WCRG) module could be introduced. This new module would process data within the same system as the CRG module 58.

Whilst it is assumed that only one service is active at a time, that service may consist of multiple simultaneous Transport layer Flow summaries (T-flows). Therefore the CRG module 58 monitors the number of simultaneous T-flows with a given GTP Flow summary (G-flow), and upon completion of the service activation (as indicated by a CA module, described below), makes available the whole SUR. For those T-flows that have no CA payload, or protocol that is not TCP, or UDP not equal to 6 or 17, the CRG module 58 outputs the SUR record based on expiry of a timer or when instructed by one of the CA modules 60.

Another function of the CRG module is to derive Application Service Provider (ASP) network addresses and associated port numbers from transport headers, and store them to be made available to the SDI module for identifying data services.

Following processing by the CRG module 58, the messages are forwarded to a set of CA (Content Analysis) modules 60. Each module is specialised for the identification and analysis of particular content in the application layer (layer 34 in FIG. 2). This application content may be a single protocol, or a set of protocols that are used to deliver a service.

Generally the CA modules 60 examine application message header content rather than actual message data. Message headers are assumed to be standard Internet headers as specified in the IETF Request for Comments RFC 822 (Format of ARPA Internet Text Messages). The CA modules are organised into a processing chain, for example with the order reflecting the volume of service use in the network. As each module 60 examines a message, it applies tests to determine whether the message should be processed or handed on. If the tests fail, the message is handed on to the next CA module 60 in the chain.

Relevant CA modules 60 are arranged to extract any Uniform Resource Identifiers (URIs) observed in HTTP and WAP protocol messages, and make the URIs thus derived available to the SDI module for use in identifying data services.

A special CA module 60 called the null CA module is placed at the end of the CA module processing chain to catch any content not recognised by the CA modules prior to it. The null module attempts to use inter-message gap analysis, the message exchange signature and analysis of port numbers to determine when a session activation has begun and ended. Unlike other CA modules it depends on the fact that only one service activation is live within a tunnel at any time, which simplifies the analysis.

A major benefit of the null CA module is that it can continue to operate normally when it is processing encrypted traffic. The analysis applied by the module is based purely on timing and traffic exchange patterns and not on the actual content.

The CA modules 60 are followed by an output formatter 62 that creates the Service Usage Records in the required format and writes them via an output module 64 to a specified output stream (file, FIFO buffer or socket). The output formatters may for example create an XML (Extensible Markup Language) format SUR, or a binary format V36 structure, or a comma-separated variable (CSV) file.

An SUR is composed of a header followed by three independent sections: G-flow, T-flow and Service Flow summary (S-flow). Each section is independent because they are built using different layers of the stack with no reference to the other layers.

The SUR has a short header section that identifies the version of SUR format. The G-Flow section contains information derived by the GTP module 56 from the outer IP, UDP and GTP layers of the stack (layers 40 to 44 in FIG. 2) and provides the ‘telecoms context’ for the following two sections. It also provides summary information on the GTP tunnel.

The T-Flow section contains measurements derived by the CRG module 58 from the tunnelled IP and TCP/UDP layers (36 and 38 in FIG. 2).

The S-flow, or ServFlow, section is a service- or protocol-specific group of measurements created by the specialised CA modules 60. The S-flow section suggests whether or not the service activation was successful as a ‘service transaction’. A service is deemed to be successful if interaction with the service provider system was possible.

It is left to the SUR consumer to use the full information in the SUR for its own purposes and decide whether it wishes to report success or failure of a service activation. The activation status code value is present to allow applications such as the GPRS QoS measurement engine to count service activations in the same manner as SS7 TCAP transactions. Where an IPDR is output after each e-mail item transfer within a session, the service status code can be obtained directly from the protocol.

Further details of possible formats for the various sections of an SUR are given in UK patent application no. 03 13 812.0 and U.S. patent application Ser. No. 10/865,573.

For the purposes of identifying data services, a “service key” to discriminate between services is assembled as follows:
Service Key=APN+ASP Network Address+ASP Port Number+URI
The APN (GPRS or UMTS Access Point Name) is a fully qualified domain name (e.g. phonecompany.co.uk), and is assigned a value in the case of GPRS and UMTS networks and is otherwise NULL (e.g. for monitoring CDMA2000 networks as described below). The APN is extracted by the GTP module 56, as mentioned above, through analysis of the GTP signalling messages that set up the GPRS ‘connection’ between the wireless network and the GPRS core network. The ASP Network address is the ASP host network address, and is usually an IPv4 or IPv6 network address in dotted-decimal format. The ASP Port Number is the port number at the ASP server used to provision the service and is a simple integer value. In principle, any network address type can be represented in the ASP Network Address field and any kind of service access point identifier can be used in the ASP Port Number field, but IP is the network protocol that will most likely be encountered in practice. Where HTTP and WAP protocols are used to provision the data service, a URI may be extracted, by the relevant CA modules 60, from a GET or POST operation request.

A configuration file is used in the SDI module to provide Service Key mapping that associates service key definitions with service names. A simple matching process can be applied to find a service name for an SUR. As an SUR is created, the state machines operating at different levels in the protocol stack extract Service Key elements from observed traffic, as described above. When an SUR is ready for output by the module 62, a procedure is invoked in the SDI module to populate a Service Name field in the SUR. All other SUR field values are known at this point. The SDI module uses the Service Key definitions listed in the configuration file to find a suitable service name. The more specific keys are conveniently defined prior to the more general keys in the configuration file, so that the first match can be used as a trigger to terminate the search for a service name.

Example Service Name entries are listed below for the BBC website (with the convention that the ‘!’ character is used as a separator and the ‘*’ character as a word wildcard in Service Key definitions):

| | |
|---|---|
| web-apn.mcc.mnc.gprs!212.58.240.111!*!www.bbc.co.uk/radio4 | “BBC Radio4” |
| web-apn.mcc.mnc.gprs!212.58.240.111!*!www.bbc.co.uk/radio | “BBC Radio” |
| web-apn.mcc.mnc.gprs!212.58.240.111!*!www.bbc.co.uk/news | “BBC News” |
| web-apn.mcc.mnc.gprs!212.58.240.111!*!* | “BBC UK” |

Another example involves SMTP which is used by MMSCs to deliver inter-carrier MMS traffic. In this example network addresses 10.224.54.20 to 22 are the MMSC Relay interfaces handling inter-carrier traffic, in the case of a service between two servers in the network rather than a mobile device and a server:

| | |
|---|---|
| *!10.224.54.20!25!* | “Inter-carrier MMS” |
| *!10.224.54.21!25!* | “Inter-carrier MMS” |
| *!10.224.54.22!25!* | “Inter-carrier MMS” |
| *!*!25!* | “Email” |

The particular implementation described above relates to monitoring of a GPRS system. Service identification can likewise be provided while monitoring other kinds of networks, for example in the case of a CDMA2000 network by monitoring packets exchanged between a home agent, analogous to a GPRS GGSN, and a packet data serving node (PDSN), analogous to a GRPS SGSN.

1. A method of identifying a service provided via a packet data system, comprising the steps of:
monitoring data packets traversing a communications link to support a data transport service in a communications network;
deriving in accordance with content of said data packets first information for identifying any access point involved in the data transport service;
deriving in accordance with content of said data packets second information identifying network address and port number associated with an application service provided involved in the data transport service;
deriving in accordance with content of said data packets third information comprising a uniform resource identifier associated with the data transport service; and
concatenating the first, second and third information to provide an identification of the data transport service.

2. The method of claim 1, wherein the data communications service is a General Packet Radio Service (GPRS) or Universal Mobile Telecommunications System (UMTS), and the first information is derived to be an access point name (APN).

3. The method of claim 1, wherein the data communications service is other than a General Packet Radio Service (GPRS) or Universal Mobile Telecommunications System (UMTS), and the first information is derived to be a null value.

4. Apparatus for identifying a service provided via a packet data system, comprising:
a monitor for monitoring data packets traversing a communications link to support a data transport service in a communications network;
a first deriver for deriving in accordance with content of said data packets first information for identifying any access point involved in the data transport service;
a second deriver for deriving in accordance with content of said data packets second information identifying network address and port number associated with an application service provided involved in the data transport service;
a third deriver for deriving in accordance with content of said data packets third information comprising a uniform resource identifier associated with the data transport service; and
a concatenator for concatenating the first, second and third information to provide an identification of the data transport service.
